(19) United States
(12) Patent Application Publication
(10) Pub. No.: US 2004/0225754 A1
(43) Pub. Date: Nov. 11, 2004

(54) Method of compressing XML data and method of decompressing compressed XML data

(75) Inventor: Ju-han Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/771,507

(22) Filed: Feb. 5, 2004

(30) Foreign Application Priority Data
Feb. 5, 2003 (KR) 2003-7120

(51) Int. Cl. G06F 15/16

(52) U.S. Cl. 709/247; 709/200

(57) ABSTRACT

A method of compressing XML data and a method of decompressing compressed XML data are provided. The method of compressing XML data includes authoring a symbol table in which each symbol that constitutes schema information representing the structure of an XML document corresponds to a compression symbol using a predetermined statistical algorithm, and replacing symbols that constitute schema information among symbols that constitute an XML document to be compressed, with corresponding compression symbols using the symbol table.

This application claims the priority of Korean Patent Application No. 2003-7120, filed on Feb. 5, 2003, in the Korean Intellectual Property Office, the disclosure of which is incorporated herein in its entirety by reference.

### BACKGROUND OF THE INVENTION

1. Field of the Invention

The present invention relates to data processing, and more particularly, to a method of compressing data having an XML format and a method of decompressing a compressed XML document.

2. Description of the Related Art

A large amount of XML data is used in a document for use in electronic commerce using Internet or an interface of a web site. Since many standards related to a document format are tending to include XML data, the importance of XML data is increased.

Currently, most XML documents are transmitted over a network, such as the Internet, while their contents are not compressed. Since XML documents have text formats due to their characteristic, they have sizes approximately 400% larger than the size of binary data having the same contents. Thus, it is required to reduce the network bandwidth used by high-capacity XML documents. For example, this reduction can be done using an efficient compression method.

In order to compress XML documents, there are conventional tools such as XMLZip manufactured by XML Solutions or XMill manufactured by Liefke and Suciu.

An XMLZip tool disassembles XML data in a tree structure, designates the depth of a root element, splits only a designated portion into a document element, and compresses the other portion into a ZIP file. The root element is not encoded but can be directly manipulated. Access to documents can be quickly performed by compressing unused portions. However, redundancy that repeatedly exists in each subtree cannot be removed. Thus, as the depth of the root element becomes larger, a compression efficiency is lowered.

An XMill tool extracts only contents of each element, i.e., only text portions, from XML data. The extracted portion is called a container. Portions related to a structure are encoded as numbers, and text portions for each container are compressed using methods such as LZ77. A user should designate a compression method for each container.

The XML compression tools compress only XML documents without considering an XML schema or a document type definition (DTD). Thus, a structural tree generated by parsing XML documents by an event processing method, is disassembled, is made as a component, and then compressed. Thus, information regarding an XML element or attribute described in an XML schema or a DTD cannot be used.

### SUMMARY OF THE INVENTION

The present invention provides a method of compressing XML data using information contained in an XML schema or a document type definition (DTD).

The present invention also provides a method of decompressing compressed XML data using the method of compressing XML data.

The present invention also provides a computer readable recording medium on which a program for implementing the method of compressing XML data and the method of decompressing compressed XML data is recorded.

According to one aspect of the present invention, there is provided a method of compressing an XML document, the method comprising authoring a symbol table in which each symbol that constitutes schema information representing the structure of an XML document corresponds to a compression symbol using a predetermined statistical algorithm, and replacing symbols that constitute schema information among symbols that constitute an XML document to be compressed, with corresponding compression symbols using the symbol table.

According to another aspect of the present invention, there is provided a method of decompressing a compressed XML document, the method comprising authoring a symbol table in which each symbol that constitutes schema information representing the structure of an XML document corresponds to a compression symbol using a predetermined statistical algorithm, and replacing compression symbols among symbols that constitute a compressed XML document to be decompressed, with symbols that constitute corresponding original schema information using the symbol table.

### BRIEF DESCRIPTION OF THE DRAWINGS

The above and other aspects and advantages of the present invention will become more apparent by describing in detail exemplary embodiments thereof with reference to the attached drawings in which:

FIG. 1 illustrates an example of a document type definition (DTD) of an XML document;

FIG. 2 illustrates an example of an XML document authored based on a DTD of FIG. 1;

FIG. 3 illustrates a method of compressing XML data according to an embodiment of the present invention;

FIG. 4 illustrates a method of compressing XML data according to another embodiment of the present invention;

FIG. 5 illustrates a method of decompressing compressed XML data using the method of compressing XML data according to the present invention; and

FIG. 6 illustrates a method of decompressing compressed XML data by generating a symbol table directly.

### DESCRIPTION OF THE PREFERRED EMBODIMENTS

Hereinafter, preferred embodiments of the present invention will be described in detail with reference to the accompanying drawings.

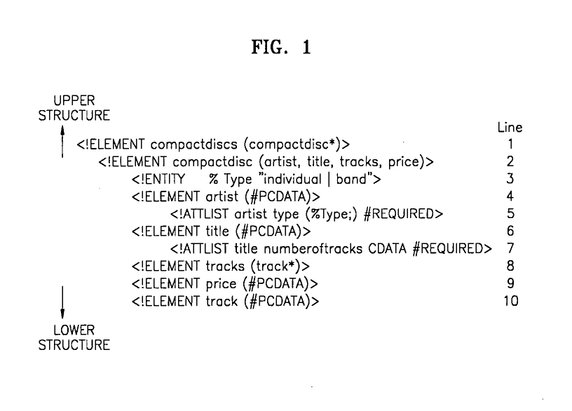

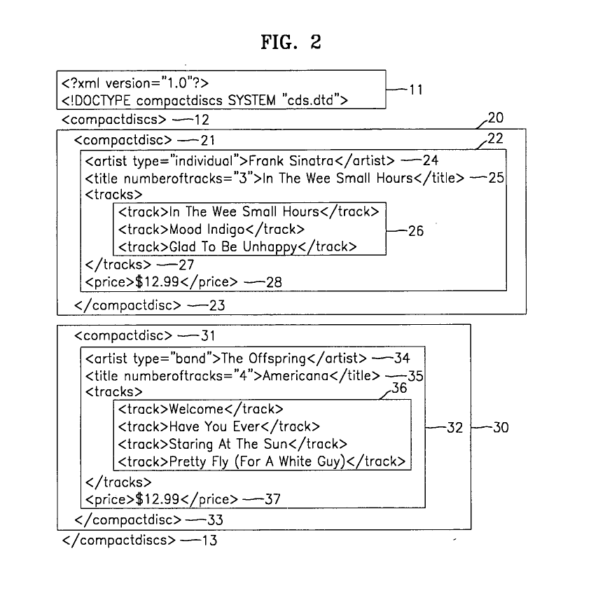

FIG. 1 illustrates an example of a document type definition (DTD) of an XML document, and FIG. 2 illustrates an example of an XML document authored based on a DTD of FIG. 1. The structure of an XML document will be described with reference to FIGS. 1 and 2.

An XML DTD includes element, attribute, and entity declarations.

Similar to the way a book consists of a chapter, a paragraph, and a column, an XML document has a structure in which specific slices are combined. The slices are called elements. An element is defined using a reserved word ‘ELEMENT’. An attribute of each element is defined using a reserved word ‘ATTLIST’ and used in the XML document in the format ‘attribute name’=“attribute value”. An entity is used to reduce any inconvenience in inputting a long text in a document several times and is defined using a reserved word ‘ENTITY’.

The first, second, fourth, sixth, and eighth to tenth lines of FIG. 1 define elements. Specific symbols may be used in defining elements. For example, “^{(*)}”, which represents repetition, is used in a first line. This shows that the ‘compactdiscs’ element can include the ‘compactdisc’ element several times. In the XML document of FIG. 2, two ‘compactdisc’ elements, 20 and 30, are declared as lower elements of the ‘compactdiscs’ element.

The second line of FIG. 1 defines ‘compactdisc’ element. The ‘compactdisc’ element includes elements ‘artist’, ‘title’, ‘tracks’, and ‘price’ as lower elements. The fourth, sixth, eighth, and ninth lines define elements ‘artist’, ‘title’, ‘tracks’, and ‘price’, respectively.

Referring to the XML document of FIG. 2, ‘compactdisc’ elements 20 and 30 include lower elements such as ‘artist’, ‘title’, ‘tracks’, and ‘price’, as defined in the DTD of FIG. 1. The first ‘compactdisc’ element, 20, has a ‘type’ attribute of “individual”, includes ‘artist’ element 24 having a value of ‘Frank Sinatra’, has a ‘numberoftracks’ attribute of “3”, and includes ‘title’ element 25 having a value of ‘In The Wee Small Hours’, ‘tracks’ element including three ‘track’ elements 26, and ‘price’ element 28 having a value of ‘$12.99’. The second ‘compactdisc’ element, 30, has a ‘type’ attribute of “band”, includes ‘artist’ element 34 having a value of ‘The Offspring’, has a ‘numberoftracks’ attribute of “4”, and includes ‘title’ element 35 having a value of ‘Americana’, a ‘track’ element including four ‘track’ elements 36, and ‘price’ element 37 having a value of ‘$12.99’.

Referring to FIGS. 1 and 2, elements defined as lower structures in a DTD appear more frequently than elements defined as upper structures. For example, in the XML document of FIG. 2, the ‘compactdisc’ element appears twice, but its upper ‘compactdiscs’ element appears only once.

According to the DTD of FIG. 1, there is no limitation regarding the number of ‘compactdisc’ elements. When many XML documents are authored based on the DTD of FIG. 1, the number of ‘compactdisc’ elements which correspond to the lower structure and ‘artist’ and ‘title’ elements that correspond to a lower structure of ‘compactdisc’ element, is much larger than the number of ‘compactdiscs’ element that correspond to the upper structure.

In FIGS. 1 and 2, the case where the structure of XML is defined based on a DTD has been explained. But in other structural XML document definition methods, there are differences in frequencies between upper elements and lower elements. The present invention is applied to a structural XML document in which elements in a lower structure appear more frequently than elements in an upper structure.

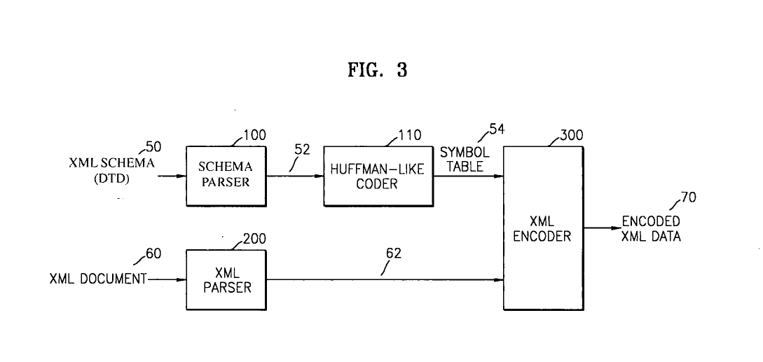

FIG. 3 illustrates a method of compressing XML data according to an embodiment of the present invention. Referring to FIG. 3, the method of compressing XML data according to the present invention will be performed as follows.

First, a file for defining the structure of an XML document, such as an XML schema or a DTD 50 is parsed using a schema parser 100, and information regarding the structure of the XML document is extracted. Hereinafter, information regarding the structure of the XML document contained in the XML schema or a DTD 50 in the description and the claims is referred to as schema information.

Meta-data 52 for elements and attributes of a corresponding XML document can be obtained by parsing the XML schema or a DTD 50. Meta-data is data including names and numbers of elements and attributes and the depth of a node, that is, data which represents schema information.

A coder 110 generates a symbol table 54 by analyzing the meta-data 52 generated in the schema parser 100 using a statistical technique. A representative example of coding using a statistical technique is Huffman coding. Coding using a statistical technique is a method of replacing original data with a compression symbol in which shorter compression symbols correspond to more frequent original data symbols and longer compression symbols correspond to rarer original data symbols. Hereinafter, the method is referred to as Huffman-like coding.

However, as described previously, in the structural XML document, an element in a lower structure, that is, a lower node appears more frequently. Thus, the Huffman-like coder 110 analyzes a generation ratio of each symbol of the meta-data 52 using a statistical technique. In the Huffman-like coder 110, shorter compression symbols correspond to more frequent data symbols and data symbols in lower nodes. The symbol table 54 which represents this corresponding relation, is generated and transmitted to an XML encoder 300.

An XML parser 200 parses an XML document 60 and transmits the result of parsing 62 to the XML encoder 300. The XML parser 200 has a simple API for XML (SAX) style or a document object model (DOM) style. The XML parser with SAX style uses events, and the XML parser with DOM style uses tree structures.

The XML encoder 300 compresses the parsed XML document 62 using the symbol table 54. The parsed XML document 62 includes portions corresponding to elements, attributes, and entities that are defined in the DTD and portions corresponding to unique text information. Elements, attributes, and entities defined in the DTD are symbols that constitute the meta-data 52, and compression symbols respectively correspond to the symbol table 54. Thus, the XML encoder 300 searches for symbols corresponding to element, attribute, and entity in the result of parsing 62 of the XML from the symbol table 54 and replaces the symbols with corresponding compression symbols.

In the case of the XML parser with SAX style, when an XML sentence, such as a sentence described in a fifth line 24 of FIG. 2 is input into the XML parser 200, the XML parser 200 generates ‘startElement(“artist”, (“type”, “individual”))’ event, ‘characters(“Frank Sinatra”)’ event, and ‘endElement(“artist”)’ event, respectively.

When in the symbol table 54, “artist” corresponds to 0×01 and “type” corresponds to 0×10, the events in the above example are replaced with ‘startElement(0×01, (0×10, “individual”)’ event, ‘characters(“Frank Sinatra”)’ event, and ‘endElement(0×01)’ event in the XML encoder 300.

A unique text of the XML document, for example, the text “Frank Sinatra” in the above example, is not defined in the DTD, and there are no compression symbols corresponding to it in the symbol table 54. Thus, the unique text is compressed using an additional compression algorithm. Several text compression methods may be used; in particular, Huffman-like compression methods may be used.

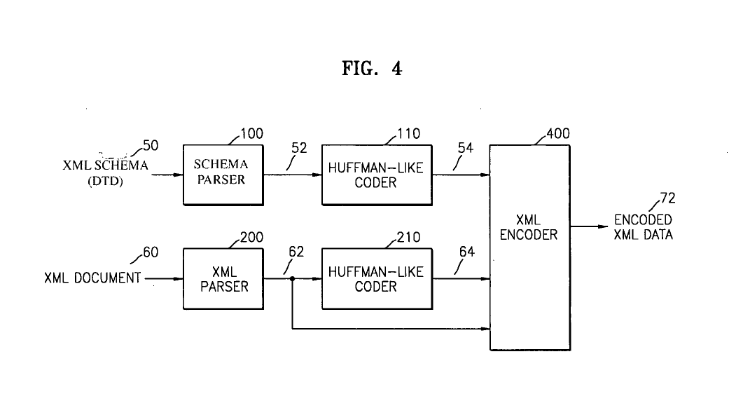

FIG. 4 illustrates a method of compressing XML data according to another embodiment of the present invention. In the method of compressing XML data shown in FIG. 4, the step of generating a symbol table 54 from an XML schema or a DTD 50 is the same as in FIG. 3.

In the embodiment of FIG. 4, the XML document 60 is parsed, and the result of parsing 62 is statistically analyzed by a second Huffman-like coder 210, and a symbol table 64 is generated in which shorter compression symbols correspond to more frequent symbols and longer compression symbols correspond to rarer symbols.

The embodiment of FIG. 4 supplements the embodiment of FIG. 3. In other words, it is guaranteed in the structural XML document that an element in a lower structure appears more frequently than an element in an upper structure. However, an actual occurrence frequency can be known by analyzing the actual XML document 60. For example, in the case of the ‘compactdisc’ element of FIG. 2, its generation number cannot be known from the DTD. It can be known that the ‘compactdisc’ element appears twice, as shown in FIG. 2, by analyzing an actual XML document. Analyzing the actual occurrence frequency leads to the ability to determine the length of a compression symbol corresponding to a certain element.

An XML encoder 400 of FIG. 4 compresses the parsed XML document 62 using the symbol table 54 generated from the XML schema or a DTD 50 and the symbol table 64 generated from the XML document.

In the method of compressing an XML document according to the present embodument, the step of generating the symbol table 54 from the XML schema or a DTD 50 is performed only once. When the symbol table 54 is generated once, in a subsequent compression step, a plurality of XML documents 60 can be compressed using the already-generated symbol table 54.

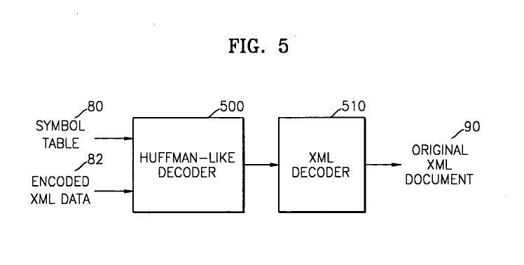

FIG. 5 illustrates a method of decompressing XML data that has been compressed using the method of compressing XML data according to the present invention.

First, a Huffman-like decoder 500 decompresses XML data using a symbol table 80 generated from an XML schema or a DTD by replacing compression symbols corresponding to symbols that constitute schema information in encoded XML data 82 with original symbols. Next, an XML decoder 510 decompresses an original XML document 90 by decompressing text portions which do not correspond to the DTD.

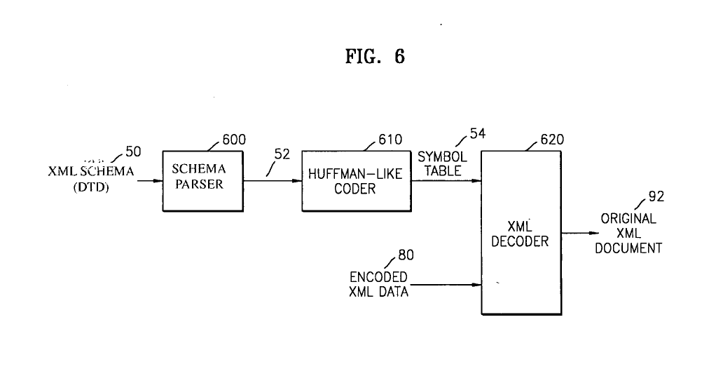

FIG. 6 illustrates a method of decompressing compressed XML data by generating a symbol table directly. When a symbol table generated in a compression step is not obtained, only an encoded XML data 82 is obtained and decompressed, a symbol table 54 is generated from the XML schema or a DTD 50.

Like in the compression step, the XML schema or a DTD 50 is parsed using a schema parser 600, and the result of parsing 52 is statistically analyzed by a Huffman-like coder 610. A symbol table 54 is generated by allocating shorter codes to more frequent lower nodes and by allocating longer codes to rarer upper nodes.

In an XML decoder 620 of FIG. 6, an original XML document 92 is decompressed using the generated symbol table 54. The XML decoder 620 of FIG. 6 includes the Huffman-like decoder 500 and the XML decoder 510 of FIG. 5.

The present invention may be embodied in a code, which can be read by a computer (including all devices having an information processing function), on a computer readable recording medium. The computer readable recording medium includes all kinds of recording apparatuses on which computer readable data are stored. The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be scattered on computer systems connected through a network and can be stored and executed as a computer readable code in a distributed mode.

As described above, in the method of compressing XML data according to the present invention, XML data is compressed by replacing more frequent symbols with shorter compression symbols and by replacing rarer symbols with longer compression symbols using schema information contained in an XML schema or a DTD, thereby improving the performance of compression. In addition, with respect to XML documents using the same schema information, a symbol table that is generated once can be reused, thereby improving the performance of compression over existing compression methods when a plurality of XML documents are compressed.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method of compressing an XML document comprising:
authoring a symbol table in which each symbol that constitutes schema information representing the structure of an XML document corresponds to a compression symbol using a predetermined statistical algorithm; and
replacing symbols that constitute schema information among symbols that constitute an XML document to be compressed, with corresponding compression symbols using the symbol table.

2. The method of claim 1, wherein the statistical algorithm in authoring a symbol table is Huffman coding.

3. The method of claim 1, wherein in authoring a symbol table, shorter compression symbols correspond to symbols in a lower structure, and longer compression symbols correspond to symbols in an upper structure in the schema information.

4. The method of claim 1, wherein the schema information is defined by an XML schema or a document type definition (DTD).

5. The method of claim 1, further comprising compressing symbols that do not correspond to the schema information among the symbols that constitute the XML document using a predetermined compression method.

6. The method of claim 5, wherein the compression method in compressing symbols is Huffman coding.

7. A method of compressing an XML document comprising:
authoring a first symbol table in which each symbol that constitutes schema information representing the structure of an XML document corresponds to a compression symbol using a predetermined statistical algorithm;
authoring a second symbol table in which symbols that constitute schema information among symbols that constitute an XML document to be compressed correspond to compression symbols using another predetermined statistical algorithm, by analyzing a number of the symbols used in the XML document; and
replacing symbols that constitute the schema information among symbols that constitute the XML document to be compressed, with corresponding compression symbols using the first and second symbol tables.

8. The method of claim 7, wherein in authoring the first symbol table, shorter compression symbols correspond to symbols in a lower structure, and longer compression symbols correspond to symbols in an upper structure in the schema information.

9. The method of claim 7, wherein the schema information is defined by an XML schema or a document type definition (DTD).

10. The method of claim 7, further comprising compressing symbols that do not correspond to the schema information among the symbols that constitute the XML document using a predetermined compression method.

11. A method of decompressing a compressed XML document comprising:
authoring a symbol table in which each symbol that constitutes schema information representing the structure of an XML document corresponds to a compression symbol using a predetermined statistical algorithm; and
replacing compression symbols among symbols that constitute a compressed XML document to be decompressed, with symbols that constitute corresponding original schema information using the symbol table.

12. The method of claim 11, wherein the statistical algorithm in authoring the symbol table is Huffman coding.

13. The method of claim 11, wherein in authoring the symbol table, shorter compression symbols correspond to symbols in a lower structure, and longer compression symbols correspond to symbols in an upper structure in the schema information.

14. The method of claim 11, wherein the schema information is defined by an XML schema or a document type definition (DTD).

15. The method of claim 11, further comprising restoring symbols that do not correspond to the compression symbols among the symbols that constitute the compressed XML document using a predetermined decompression method.

16. A method of decompressing a compressed XML document, comprising:
replacing compression symbols among symbols that constitute a compressed XML document to be decompressed, with symbols that constitute corresponding original schema information; and
using a symbol table in which each symbol that constitutes schema information representing the structure of an XML document corresponds to a compression symbol using a predetermined statistical algorithm.

17. The method of claim 16, wherein the statistical algorithm used in the symbol table is Huffman coding.

18. The method of claim 16, wherein in the symbol table, shorter compression symbols correspond to symbols in a lower structure, and longer compression symbols correspond to symbols in an upper structure in the schema information.

19. The method of claim 16, wherein the schema information is defined by an XML schema or a document type definition (DTD).

20. The method of claim 16, further comprising restoring symbols that do not correspond to the compression symbols among the symbols that constitute the compressed XML document using a predetermined decompression method.
